(19) United States
(12) Patent Application Publication
(10) Pub. No.: US 2011/0187683 A1
(43) Pub. Date: Aug. 4, 2011

(54) ELECTRO-OPTIC DISPLAYS WITH SINGLE EDGE ADDRESSING AND REMOVABLE DRIVER CIRCUITRY

(75) Inventors: Russell J. Wilcox, Natick, MA (US); Jonathan D. Albert, Philadelphia, PA (US); Holly G. Gates, Somerville, MA (US)

(73) Assignee: E INK CORPORATION, Cambridge, MA (US)

(21) Appl. No.: 13/084,860

(22) Filed: Apr. 12, 2011

Related U.S. Application Data
(62) Division of application No. 10/977,128, filed on Oct. 29, 2004, now abandoned.
(60) Provisional application No. 60/515,547, filed on Oct. 30, 2003.

(51) Int. Cl. G06F 3/038; G09G 3/20

(52) U.S. Cl. 345/204; 345/55

(57) ABSTRACT

An edge-addressable electronic display is provided including a row electrode in electric communication with a first termination and a column electrode in electric communication with a second termination. The row and column electrodes intersect at a pixel. Both the first and second terminations are disposed proximate to a first edge of the display, and as a result, the pixel may be addressed along the first edge of the display. The display may further include a removable driver circuitry for addressing the pixel in electric communication with at least one of the first and second terminations.

### REFERENCE TO RELATED APPLICATIONS

This application is a continuation of copending application Ser. No. 10/977,128, filed Oct. 29, 2004, which claims benefit of Application Ser. No. 60/515,457 filed Oct. 29, 2003, the entire disclosure of which is incorporated herein by reference.

### BACKGROUND OF INVENTION

The present invention relates to electronic displays, and, more particularly, to nonemissive electro-optic displays addressable along one edge.

Electronic displays typically used today are rigid and frequently contain one or more sheets of rigid material. For example, liquid crystal displays have been traditionally manufactured by enclosing an optoelectrically active material between two pieces of breakable glass. These panel-type electronic display devices typically require a control circuit mounted on a rigid circuit board. For example, liquid crystal displays commonly used in laptop computers typically have several integrated circuits mounted on circuit boards arranged around the liquid crystal portion of the panel. As panels of increasing size and resolution are developed, larger and heavier circuit boards are required in the manufacture of the display. Such printed circuit boards are expensive to manufacture and present additional costs and complexity of physical and electrical interfacing with other display components. The added manufacturing steps required to connect the electrical conductors on the display medium portion of a display with the electrical conductors on a circuit board may also lead to a yield loss.

It would be desirable, for many applications, to have thin, flexible displays. The cost of circuit boards and the difficulty in mating of circuit boards to substrates, however, are two impediments to realization of the advantages of flexible displays.

Recently, progress has been made in developing a new type of a flexible display—an encapsulated electrophoretic display. Electrophoretic display media, generally characterized by the movement of particles through an applied electric field, are highly reflective, can be made bistable, and consume very little power. Encapsulated electrophoretic displays also enable the display to be printed. These properties allow encapsulated electrophoretic display media to be used in many applications for which traditional electronic displays, including liquid crystal media displays, are not suitable.

These electrophoretic displays can be addressed directly, by a flexible array of transistors, or passively. The addressing is controlled through logic circuitry, frequently in the form of display driver chips. In a typical electronic display, addressing is conducted by means of rows and columns. Referring to FIG. 1, in a typical array, the rows 10 and columns 15 terminate at the different edges or borders of the display media. The edges may have conductive pads 18 disposed thereon. Driver chips are typically provided on more than one edge of the array. The driver chips may be bonded to the line terminations or conductive pads, for example, with TAB bonding. Conventionally, the row and column driver chips are connected immediately adjacent the row and column terminations and, therefore, span in more than one direction or along more than one edge.

The electro-optical properties of encapsulated flexible displays, however, allow, and in some cases may require, novel schemes or configurations to be used to address the displays. Specifically, driver chips are typically rigid or prone to breakage if flexed. If the objective is to create a physically flexible display, then disposing inflexible driver chips along two or more edges of the display may compromise the functionality a flexible substrate. While such a substrate may still be more resistant to physical shock than a rigid glass display, its ability to be rolled or folded will be limited.

Also, for many displays, the cost of the driver chips is often significant and can outweigh the cost of the display substrate. Further, the driver chips themselves require rather costly module electronics. However, the substrate of physically bendable flexible displays may be bent beyond tolerance, may suffer wear and tear that reduce its lifecycle, or may otherwise cease to usefully function long before the failure of the drive electronics.

Further, flexible displays may be associated with applications where portability is a desired attribute. Portability is enhanced when the user is able to access a large image through a flexible display reduced. to a smaller size by folding or rolling.

### SUMMARY OF INVENTION

Thus, it is an object of the invention to provide an electro-optic display that addresses the disadvantages of known methods of connecting such displays to driver circuitry. Combined use of flexible substrates and lower-cost conductor printing methods holds the potential for a lower-cost displays for a variety of uses, including rollable displays, affordable large area displays, displays incorporated into fabrics, smart cards, multi-page electronic books, paper substitutes, and many other applications. Specifically, it is an object of the invention to provide a display that is addressable along one edge. It is another object of the invention to preserve the value of the expensive and durable electronic components of the display by re-using driver circuitry with different displays. It is yet another object of the invention to provide users of portable electronic devices with improved access to compatible large display screens. These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

Accordingly, in one aspect, the present invention is directed to an edge-addressable electronic display that includes a row electrode in electric communication with a first termination and a column electrode in electric communication with a second termination. The column electrode intersects with the row electrode at a pixel. Both the first and second terminations are disposed proximate to a first edge of the display, and as a result, the pixel may be addressed along the first edge of the display. The display may further include a driver circuitry for addressing the pixel in electric communication with at least one of the first and second terminations. As used herein, the terms “driver circuitry” refers to display drive electronics, including an array of pixel-addressing chips controlled through logic circuitry. In various embodiments of the invention, at least part of the driver circuitry may be reversibly removable or disconnectable from the display. In some embodiments, the driver circuitry may be an integral part of or electrically connected to an electronic device, which may have an internal display addressable by the driver circuitry. In other embodiments, the driver circuitry is a part of an addressing module connectable to the first edge of the display.

The electronic display may include a nonemissive electro-optic display medium, such as, for example, an electrochromic display medium, a microcell electrophoretic display medium, or a rotating bichromal member display medium. In one embodiment, the nonemissive electro-optic display medium is an encapsulated electrophoretic display medium that includes at least one capsule dispersed in a binder phase, the at least one capsule containing an electrophoretic contrast medium phase that includes at least one particle and suspending fluid. In another embodiment, the nonemissive electro-optic display medium is a encapsulated electrophoretic display medium that includes a plurality of cavities dispersed in a polymeric matrix, wherein at least one of said plurality of cavities contains an electrophoretic contrast media phase that includes at least one particle in a suspending fluid.

In another aspect, the invention is directed to a method for addressing a display including the steps of disposing a first termination and a second termination proximate to a first edge of the display, and providing a row electrode and a column electrode in communication with a first termination and a second termination, respectively. The row and column electrodes intersect with each other at a pixel. The method further includes the step of directing an electrical signal to at least one of the first and second terminations. The method may further include the step of providing a driver circuitry in electrical communication with at least one of the first and second terminations, at least part of the driver circuitry being reversibly removable from the display.

In yet another aspect, the invention is directed to an edge-addressable electronic display including a plurality of row electrodes terminating at a plurality of row electrode terminations and a plurality of column electrodes intersecting with the plurality of row electrodes at a plurality of pixels. The plurality of column electrodes may be in electric communication with a plurality of column electrode terminations via a plurality of traces. Furthermore, the plurality of row electrode terminations and the plurality of column electrode terminations are disposed proximate to a first edge of the display, thus enabling addressing of the display pixels along this first edge of the display. The display may further include a driver circuitry in electrical communication with the row electrode terminations and the column electrode terminations, at least part of the circuitry being reversibly removable therefrom.

### BRIEF DESCRIPTION OF DRAWINGS

The advantages of the invention may be better understood by referring to the following detailed description taken in conjunction with the accompanying drawings. The drawings are not necessarily to scale, emphasis instead generally being placed upon illustrating the principles of the invention.

FIG. 1 is a schematic representation of the electrode configuration for addressing electro-optic displays according to methods known in the art;

FIGS. 2A-2C are schematic representations of the electrode configurations for addressing electro-optic displays according to various embodiments of the invention, illustrating different ways to arrange conductive traces relative to the electrodes;

FIG. 3A is a schematic representation of a shelf display unit including an electro-optic display of the invention;

FIG. 3B is a perspective view of the shelf display unit of FIG. 3A;

FIG. 4A is a schematic representation of an electronic device generating an image on a separate electro-optic display according to one embodiment of the invention; and

FIG. 4B is a schematic representation of the electrode configuration for addressing the electro-optic display of FIG. 4A.

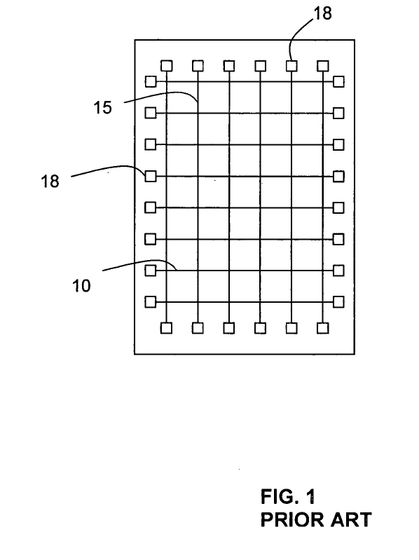

### DETAILED DESCRIPTION

A. Some General Principles of Electro-Optic Displays

Electro-optic displays include a layer of electro-optic material, a term which is used herein in its conventional meaning in the art to refer to a material having first and second display states differing in at least one optical property, the material being changed from its first to its second display state by application of an electric field to the material. The optical property is typically color perceptible to the human eye, but may be another optical property, such as optical transmission, reflectance, luminescence or, in the case of displays intended for machine reading, pseudo-color in the sense of a change in reflectance of electromagnetic wavelengths outside the visible range.

The electro-optic displays in which the method of the present invention is used typically contain an electro-optic material which is a solid in the sense that the electro-optic material has solid external surfaces, although the material may, and often does, have internal liquid- or gas-filled space. Such displays using solid electro-optic materials may hereinafter for convenience be referred to as “solid electro-optic displays.”

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791, all incorporated herein by reference. Although this type of display is often referred to as a “rotating bichromal ball” display, the term “rotating bichromal member” is preferred as more accurate since in some of the patents mentioned above the rotating members are not spherical. Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed to applying an electric field thereto, thus rotating the bodies to various positions and varying which of the sections of the bodies is seen through a viewing surface.

Another type of electro-optic medium uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; Wood, D., Information Display, 18(3), 24 Mar. 2002); and Bach, U., et al., Adv. Mater., 2002, 14(11), 845, all incorporated herein by reference. Nanochromic films of this type are also described, for example, in U.S. Pat. No. 6,301,038, International Application Publication No. WO 01/27690, and in U.S. Patent Application Publication No. 2003/0214695, all incorporated herein by reference.

Yet another type of electro-optic display, which has been the subject of intense research and development for a number of years, is the particle-based electrophoretic display, in which a plurality of charged particles move through a suspending fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a suspending fluid. In most prior art electrophoretic media, this suspending fluid is a liquid, but electrophoretic media can be produced using gaseous suspending fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspending medium, and a capsule wall surrounding the internal phase. Typically, the capsules are themselves held within a polymeric binder to form a coherent layer positioned between two electrodes. Encapsulated media of this type are described, for example, in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,271; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; 6,580,545; 6,639,578; 6,652,075; 6,657,772; 6,664,944; 6,680,725; 6,683,333; 6,704,133; 6,710,540; 6,721,083; 6,727,881; 6,738,050; 6,750,473; and 6,753,999; and U.S. Patent Applications Publication Nos. 2002/0019081; 2002/0021270; 2002/0060321; 2002/0063661; 2002/0090980; 2002/0113770; 2002/0130832; 2002/0131147; 2002/0171910; 2002/0180687; 2002/0180688; 2002/0185378; 2003/0011560; 2003/0020844; 2003/0025855; 2003/0038755; 2003/0053189; 2003/0102858; 2003/0132908; 2003/0137521; 2003/0137717; 2003/0151702; 2003/0214695; 2003/0214697; 2003/0222315; 2004/0008398; 2004/0012839; 2004/0014265; 2004/0027327; 2004/0075634; 2004/0094422; 2004/0105036; 2004/0112750; and 2004/0119681; and International Applications Publication Nos. WO 99/67678; WO 00/05704; WO 00/38000; WO 00/38001; WO00/36560; WO 00/67110; WO 00/67327; WO 01/07961; WO 01/08241; WO 03/107,315; WO 2004/023195; and WO 2004/049045, all incorporated herein by reference.

Many of the aforementioned patents and applications recognize that the walls surrounding the discrete microcapsules in an encapsulated electrophoretic medium could be replaced by a continuous phase, thus producing a so-called polymer-dispersed electrophoretic display in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. Reference to “printing” is intended to include all forms of printing and coating, including, but not limited to: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made relatively inexpensively.

A related type of electrophoretic display is a so-called “microcell electrophoretic display”. In a microcell electrophoretic display, the charged particles and the suspending fluid are not encapsulated within microcapsules but instead are retained within a plurality of cavities formed within a carrier medium, typically a polymeric film. See, for example, International Application Publication No. WO 02/01281, and published US Application No. 2002/0075556, both assigned to Sipix Imaging, Inc. and incorporated herein by reference. Other types of electro-optic materials may also be used in the displays of the present invention.

B. Addressing of Electro-Optic Displays

In addition to the layer of electro-optic material, many electro-optic displays include at least two other layers disposed on opposite sides of the electro-optic material, one of these two layers being an electrode layer. Typically, both layers are electrode layers, and one or both of the electrode layers are patterned to define the pixels of the display. For example, one electrode layer has the form of a single continuous electrode and the other electrode layer is patterned into a matrix of pixel electrodes, each of which defines one pixel of the display.

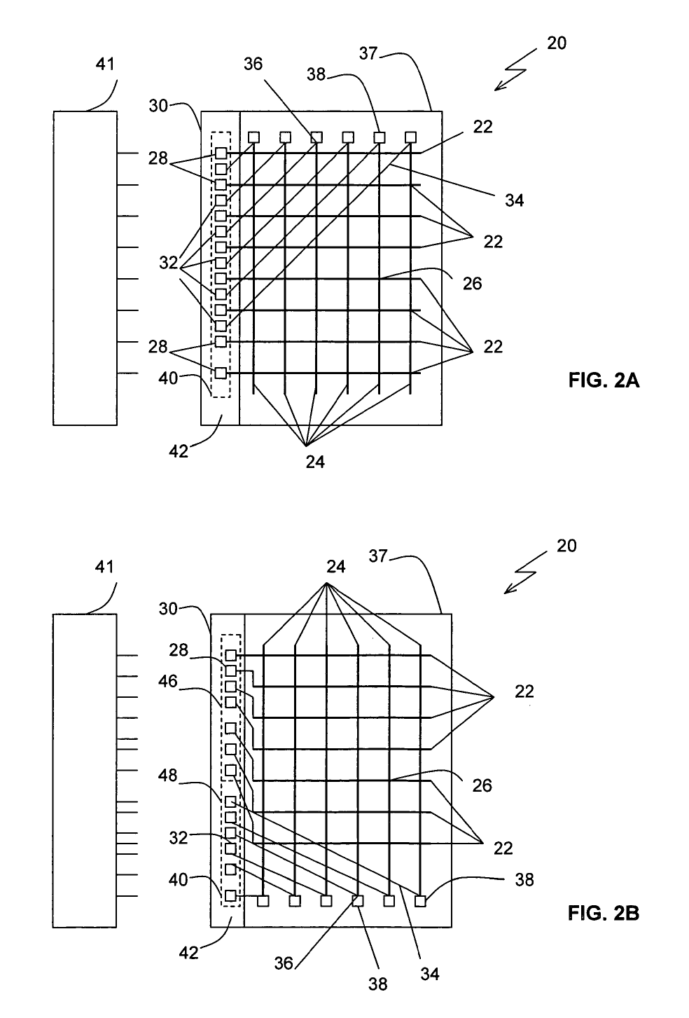

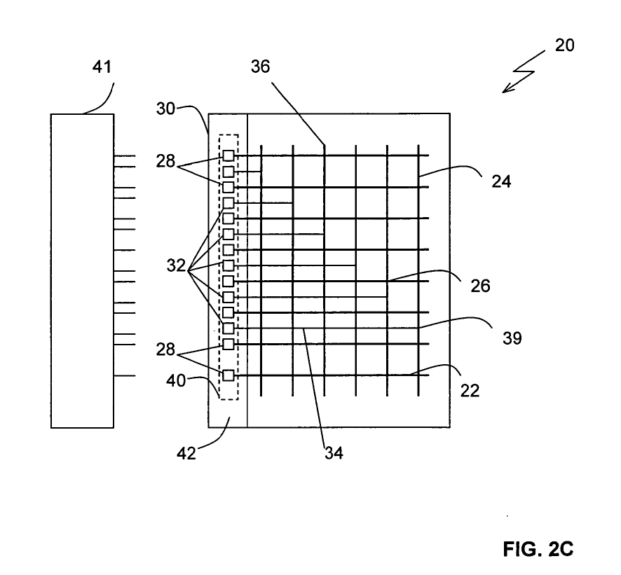

Referring to FIG. 2A, in one embodiment, an electro-optic display 20 includes one electrode layer patterned into one or more elongate row electrodes 22 and the other electrode layer patterned into one or more elongate column electrodes 24 intersecting with row electrodes 22, for example, running at about right angles to the row electrodes, the pixels 26 being defined by the intersections of the row and column electrodes. The terms “row” and “column” electrodes are used to designate substantially perpendicular patterned electrodes, and can be used interchangeably.

The display 20 may be inflexible or rigid. However, in a particular embodiment, part or the entire display 20 is flexible or semi-flexible. Each row electrode 22 may have a conductive pad 28 at its termination proximate to an edge 30 of the display 20. An additional array of conductive pads 32 may be provided along the edge 30 at an array of terminations for the column electrodes 24. The pads 32 may be placed in electrical communication with the column electrodes 24 by conductive traces 34, each trace 34 running at an angle to the corresponding column electrode 24 intersecting it at a terminal column connection 36 proximate to a second edge 37 of the display 20. In one embodiment, the angle between each trace 34 and the corresponding column electrode 24 is about 45 degrees. Other configurations of the traces 34 connecting column electrodes 24 to the respective conductive pads 32 disposed along the edge 30 are also contemplated by the invention. In some embodiments, driver chips may be bonded to or disposed in place of the pads 28, 32.

In some versions of this embodiment, the display media is coated with a dielectric (not shown) having gaps adjacent to each terminal column connection 36 and along a series of pads 28, 32 along the edge 30. The conductive traces 34 may then be deposited over the dielectric connecting each terminal column connection 36 with the corresponding pad 32. In one embodiment, the conductive traces 34 are printed using screen-printing methods. The conductive traces 34 and the column connections 36 may then be coated with a dielectric or other protective layer, leaving only the pads 28, 32 exposed along the edge 30 forming a connection strip 40. In one embodiment, there is a conductive pad 38 disposed over or bonded to each column connection 36. In another embodiment, there is no pad or other additional structure at each column connection 36 for maximum flexibility along the horizontal axis.

This arrangement of conductive pads 28, 32 along the edge 30 according to various embodiments of the invention facilitates physical flexure of the display, for example, rolling the display about an axis parallel to the edge 30, because inflexible connection pads or driver chips attached thereto are disposed along only one edge of the display. In various embodiments, a reinforcing layer 42 is disposed over the connection strip 40 to protect the connection strip 40 from flexure while the display is being bent. Other reinforcing means may also be employed, such as springs, elastics, grips, and pins through physical holes in the display media.

The connection strip 40 represents the site where the row and column electrodes 22, 24 are accessible for addressing by a driver circuitry 41. The display 20 is imaged by having driver circuitry 41 generate and bring the desired sequence of electrical impulses into electrical communication with the connection strip 40. The row and column pads 28, 32 may be arranged in a variety of patterns in the connection strip 40. For example, as shown in FIG. 2A, column pads 32 may be interspersed with row pads 28. Referring to FIG. 2B, in another embodiment, the row pads 28 and the column pads 32 may be separated into distinct regions 46 and 48, respectively. The embodiment of the connection strip 40 shown in FIG. 2B facilitates attachment of driver circuitry having chips of different types, such as, for example, driver chips operating at different voltages.

Referring to FIG. 2C, in yet another embodiment, the conductive traces 34 may connect the conductive pads 32 with the column electrodes 24 by intersecting the column electrodes 24 at about right angles. As such, each of the conductive traces 34 may intersect a respective column electrode at an intermediary point 39, rather than at the terminal column connection 36.

In various versions of the embodiments described in connection with FIGS. 2A-2C, the electro-optic display 20 having the connection strip 40 with exposed conductive pads 28, 32, or, in some embodiments, driver chips disposed over and bonded to or in place of the pads 28, 32, are not permanently connected to the driver circuitry 41. Thus, the driver circuitry 41 can be removably connected to the display in a temporary and reversible fashion, using a contact connector, a clamped connection, a zebra strip, or some other connection means. This permits the display media to be used with replaceable or disposable flexible displays, because new display media could be cheaply substituted. Also, by de-coupling the driver circuitry 41 and the display 20, the cost of the driver circuitry can be distributed across several displays. The user depresses a switch or a switch is automatically depressed when the driver circuitry is affixed and the display is activated. Upon removing the driver, the display, e.g., a bistable display, is left in its last state.

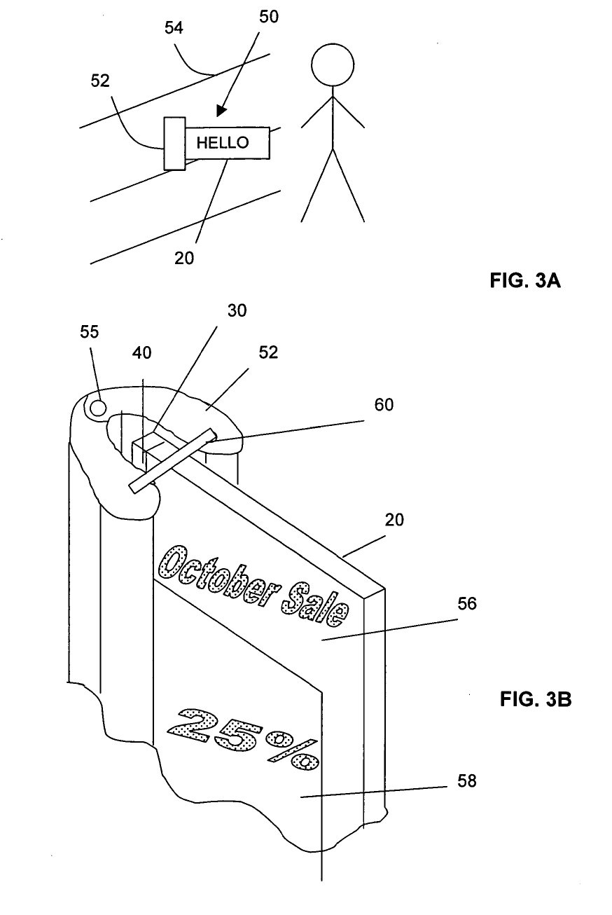

There are many commercial applications of the invention described above. For example, referring to FIG. 3A, in a retail environment, a shopper walking down a store aisle can be greeted by a shelf display unit 50 that includes the electro-optic display 20 attached to and controlled by a base addressing module 52 having driver circuitry and disposed on a shelf 54. In one embodiment, the display 20 is flexible and withstands curious flexing or being brushed against by shoppers. In one embodiment, the display 20 is disposable and can be replaced if damaged without replacing the more expensive module 52. Referring to FIG. 3B, in this exemplary embodiment, the display 20 is, e.g., a monochrome text display having an eye-catching color image, such as, for example, “October Savings” or “October Sale” imprinted in a margin 56. The flexible display may cycle through messages describing specials on nearby shelves imaged in an active area 58. When the month of October passes, a November-specific message is printed onto a new display. The October display 20 is then replaced by releasing a clasp 60, removing the “October” display from the base addressing module 52, and inserting a “November” display into the module 52 until the connection strip 40 of the display 20 engages the same driver circuitry in the base addressing module 52. Optimally, the base module 52 may include a hinge 55 to facilitate the placement and replacement of the display 20. In some embodiments, the module 52 has a groove (not shown) for receiving connection strip 40 at the edge 30 of the display 20 within the base module 52 and securing the strip 40 in electric communication with display circuitry. The module 52 may have an internal display (not shown) addressable by the driver circuitry as discussed in more detail below.

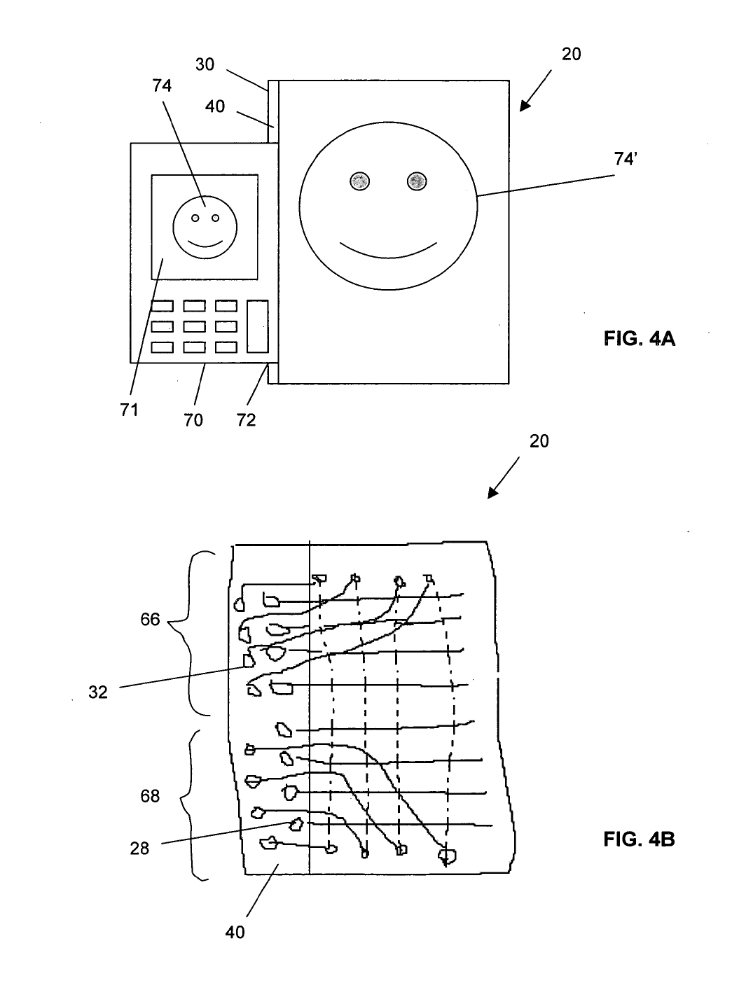

Disposable displays according to various embodiments of the invention could also be used as auxiliary magnifying displays for other electronic devices such as pagers, cellular phones, PDAs, computers, laptops, electronic books, two-way radios, set-top boxes, and webpads, particularly, handheld devices having internal displays with relatively small screens. Referring to FIG. 4A, in one embodiment, the electro-optic display 20 having the connection strip 40 with exposed conductive pads 28, 32 at the edge 30 of the display 20 is used as an auxiliary display for a base device 70, for example, a cellular phone, having an internal screen 71. The base device 70 has a groove 72 formed along an edge of the base device 70 into which the connection strip 40 is inserted. Corresponding electric contacts (not shown) disposed inside the groove 72 facilitate a connection between the driver circuitry of the base device 70 and the pads 28, 32 of the display. When the user desires to view an image 74 appearing on the internal screen 71 using the larger display 20, for example, to view a magnified version of the image 74, he or she inserts the edge 30 of the display 20 into the groove 72 until the electric contacts in the groove 72 are engaged with the connection strip 40. The pads 28, 32 may then be activated either through an appropriate sensor or manually by the user, for example, by pressing an activation button on the base device 70, to cause the driver circuitry to address the display 20 so that an image 74′, identical in appearance yet larger than the image 74, appears on the display 20 in addition to, or instead of, the image 74 appearing on the screen 71. The size of the image 74′ may be enlarged or magnified to beyond the length of the groove 72. For example, in one embodiment, the connection strip 40 may concentrate connection pads 28 for rows across 8″ of the display 20 into a region only 2″ in length. Or, appropriate connections may be repeated at various regions 66 and 68 along the connection strip 40, as shown in FIG. 4B, and the base device 70 is sequentially brought into contact with the connection strip 40 at various regions 66 and 68 along the strip. Other methods of attaching the display 20 to a base device 70 are described in the aforementioned 2002/0130832.

One advantage of using a bistable or multistable media in the display 20 is that the base device 70 performs much like a printer in this example, causing the image 74 to appear and persist along the page. For example, a cellular phone user who has received a fax could pull out a few sheets of disposable display media and cause the image of the fax to appear on the sheets by inserting each of the connection strip of each of the sheets into the groove 72. To fix the image in a permanent medium, these sheets may be used as originals in a traditional paper copier and then reused for the next incoming fax. Similarly, the cellular phone user may in this fashion “print out a large number of emails to be read at leisure.

The connection strip 40 may include printed markings, transparent regions, physical features, electrical patterns or any other suitable means that would enable the base device 70 to align itself to the orientation of the display media 20 or to sense which row and column are in electrical communication with the base device 70. This may enable the base device 70 to be applied multiple times and at multiple locations to the display media 20 in a manner where a composite image is formed.

Additionally, by providing a storage element, for example, a memory chip (not shown), within the display, the driver circuitry can interrogate the display and determine information about the type of display and how it should be controlled. The memory element can also store information on the display. For example, the display can reflect how many times it has been accessed over a period of time. The memory element can be a EEPROM chip disposed on the substrate of the display.

While the display media described above is preferably flexible, the electrode arrangements described hereinabove would also be useful for rigid display media, such as, for example, liquid crystal displays.

C. Illustrative Examples of Display Media

The features of the invention mentioned above can be employed in an electro-optic display that includes any of a variety of display media, as described above and further described below. Such display media include, for example, an electrophoretic display medium, a rotating ball medium or an electrochromic medium. For example, such display media can include nonemissive display elements such as particles, particle-containing capsules (e.g., microencapsulated electrophoretic display elements), bichromal spheres or cylinders, or rotating round balls, dispersed in a binder. As a further example, an electrochromic medium can be used as a nonemissive display medium.

An electrochromic medium can be in the form of a nanochromic film comprising an electrode formed at least in part from a semi-conducting metal oxide and a plurality of dye molecules capable of reversible color change attached to the electrode.

Several types of known bistable electro-optic display media may be used in conjunction with features of the invention, as mentioned above. For example, the invention may use a rotating bichromal member display. Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface.

An electro-optic display can be constructed so that the optical state of the display is stable for some length of time. When the display has two states that are stable in this manner, the display is bistable. If more than two states of the display are stable, then the display is multistable. For the purpose of the present invention, the term “bistable” indicates a display in which any optical state remains fixed once the addressing voltage is removed. However, the definition of a bistable state depends upon the display's application. A slowly decaying optical state can be effectively bistable if the optical state is substantially unchanged over the required viewing time. For example, in a display that is updated every few minutes, a display image that is stable for hours or days is effectively bistable for a particular application. Thus, for purposes of the present invention, the term bistable also indicates a display with an optical state sufficiently long-lived so as to be effectively bistable for a particular application. Alternatively, it is possible to construct encapsulated electrophoretic displays in which the image decays quickly once the addressing voltage to the display is removed (i.e., the display is not bistable or multistable). Whether or not an encapsulated electrophoretic display is bistable, and its degree of bistability, can be controlled through appropriate chemical modification of the electrophoretic particles, the suspending fluid, the capsule, and binder materials.

Features of the invention may be utilized in displays that include unencapsulated electrophoretic media or encapsulated electrophoretic media, for example, encapsulated in a plurality of capsules or in a microcell structure. In a microcell electrophoretic display, the charged particles and the suspending fluid are not encapsulated within microcapsules but instead are retained within a plurality of cavities formed within a carrier medium, typically a polymeric film.

When the display medium includes particle-containing capsules, the capsules may be of any size or shape. In one embodiment of the invention, the capsules are spherical and have diameters in the millimeter or micron range. In a particular embodiment, the capsule diameters are from about ten to about a few hundred microns. The capsules may be formed by an encapsulation technique and, in one embodiment, include two or more different types of electrophoretically mobile particles. The walls surrounding discrete microcapsules, in, for example, an encapsulated electrophoretic medium, can be replaced by a continuous phase, thus producing a so-called polymer-dispersed electrophoretic display in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet.

Some useful materials for constructing encapsulated electrophoretic displays are discussed below.

### Particles

There is much flexibility in the choice of particles for use in electrophoretic displays, as described above. For purposes of this invention, a particle is any component that is charged or capable of acquiring a charge (i.e., has or is capable of acquiring electrophoretic mobility), and, in some cases, this mobility may be zero or close to zero (i.e., the particles will not move). The particles may be neat pigments, dyed (laked) pigments or pigment/polymer composites, or any other component that is charged or capable of acquiring a charge. Typical considerations for the electrophoretic particle are its optical properties, electrical properties, and surface chemistry. The particles may be organic or inorganic compounds, and they may either absorb light or scatter light. The particles for use in the invention may further include scattering pigments, absorbing pigments and luminescent particles. The particles may be retroreflective, such as corner cubes, or they may be electroluminescent, such as zinc sulfide particles, which emit light when excited by an AC field, or they may be photoluminescent. Finally, the particles may be surface treated so as to improve charging or interaction with a charging agent, or to improve dispersibility.

One exemplary material to form particles useful in electrophoretic displays of the invention is titania. The titania particles may be coated with a metal oxide, such as aluminum oxide or silicon oxide, for example. The titania particles may have one, two, or more layers of metal-oxide coating. For example, a titania particle for use in electrophoretic displays of the invention may have a coating of aluminum oxide and a coating of silicon oxide. The coatings may be added to the particle in any order.

The electrophoretic particle is usually a pigment, a polymer, a laked pigment, or some combination of the above. A neat pigment can be any pigment, and, usually for a light colored particle, pigments such as, for example, rutile (titania), anatase (titania), barium sulfate, kaolin, or zinc oxide are useful. Some typical particles have high refractive indices, high scattering coefficients, and low absorption coefficients. Other particles are absorptive, such as carbon black or colored pigments used in paints and inks The pigment should also be insoluble in the suspending fluid. Yellow pigments such as diarylide yellow, hansa yellow, and benzidin yellow have also found use in similar displays. Any other reflective material can be employed for a light colored particle, including non-pigment materials, such as metallic particles.

Useful neat pigments include, but are not limited to, PbCrO₄, Cyan blue GT 55-3295 (American Cyanamid Company, Wayne, N.J.), Cibacron Black BG (Ciba Company, Inc., Newport, Del.), Cibacron Turquoise Blue G (Ciba), Cibalon Black BGL (Ciba), Orasol Black BRG (Ciba), Orasol Black RBL (Ciba), Acetamine Blac, CBS (E. I. du Pont de Nemours and Company, Inc., Wilmington, Del.), Crocein Scarlet N Ex (du Pont) (27290), Fiber Black VF (DuPont) (30235), Luxol Fast Black L (DuPont) (Solv. Black 17), Nirosine Base No. 424 (DuPont) (50415 B), Oil Black BG (DuPont) (Solv. Black 16), Rotalin Black RM (DuPont), Sevron Brilliant Red 3 B (DuPont); Basic Black DSC (Dye Specialties, Inc.), Hectolene Black (Dye Specialties, Inc.), Azosol Brilliant Blue B (GAF, Dyestuff and Chemical Division, Wayne, N.J.) (Solv. Blue 9), Azosol Brilliant Green BA (GAF) (Solv. Green 2), Azosol Fast Brilliant Red B (GAF), Azosol Fast Orange RA Conc. (GAF) (Solv. Orange 20), Azosol Fast Yellow GRA Conc. (GAF) (13900 A), Basic Black W A (GAF), Benzofix Black CW-CF (GAF) (35435), Cellitazol BNFV Ex Soluble CF (GAF) (Disp. Black 9), Celliton Fast Blue AF EX Conc (GAF) (Disp. Blue 91, Cyper Black IA (GAF) (Basic Blk. 3), Diamine Black CAP Ex Conc (GAF) (30235), Diamond Black EAN Hi Con. CF (GAF) (15710), Diamond Black PBBA Ex (GAF) (16505); Direct Deep Black EA Ex CF (GAF) (30235), Hansa Yellow G (GAF) (11680); Indanthrene Black BBK Powd. (GAF) (59850), Indocarbon CLGS Conc. CF (GAF) (53295), Katigen Deep Black NND Hi Conc. CF (GAF) (15711), Rapidogen Black 3 G (GAF) (Azoic Blk. 4); Sulphone Cyanine Black BA-CF (GAF) (26370), Zambezi Black VD Ex Conc. (GAF) (30015); Rubanox Red CP-1495 p e Sherwin-Williams Company, Cleveland, Ohio) (15630); Raven 11 (Columbian Carbon Company, Atlanta, Ga.), (carbon black aggregates with a particle size of about 25 μm), Statex B-12 (Columbian Carbon Co.) (a furnace black of 33 μm average particle size), and chrome green.

Particles may also include laked, or dyed, pigments. Laked pigments are particles that have a dye precipitated on them or which are stained. Lakes are metal salts of readily soluble anionic dyes. These are dyes of azo, triphenylmethane or anthraquinone structure containing one or more sulphonic or carboxylic acid groupings. They are usually precipitated by a calcium, barium or aluminum salt onto a substrate. Typical examples are peacock blue lake (CI Pigment Blue 24) and Persian orange (lake of CI Acid Orange 7), Black M Toner (GAF) (a mixture of carbon black and black dye precipitated on a lake).

A dark particle of the dyed type may be constructed from any light absorbing material, such as carbon black, or inorganic black materials. The dark material may also be selectively absorbing. For example, a dark green pigment may be used. Black particles may also be formed by staining latices with metal oxides, such latex copolymers consisting of any of butadiene, styrene, isoprene, methacrylic acid, methyl methacrylate, acrylonitrile, vinyl chloride, acrylic acid, sodium styrene sulfonate, vinyl acetate, chlorostyrene, dimethylaminopropylmethacrylamide, isocyanoethyl methacrylate and N-(isobutoxy-methacrylamide), and optionally including conjugated diene compounds such as diacrylate, triacrylate, dimethylacrylate and trimethacrylate. Black particles may also be formed by a dispersion polymerization technique.

In the systems containing pigments and polymers, the pigments and polymers may form multiple domains within the electrophoretic particle, or be aggregates of smaller pigment/polymer combined particles. Alternatively, a polymer shell may surround a central pigment core. The pigment, polymer, or both may contain a dye. The optical purpose of the particle may be to scatter light, absorb light, or both. Useful sizes may range from 1 nm up to about 100 μm, as long as the particles are smaller than the bounding capsule. In various embodiments, the density of the electrophoretic particle may be substantially matched to that of the suspending (i.e., electrophoretic) fluid. As defined herein, a suspending fluid has a density that is “substantially matched” to the density of the particle if the difference in their respective densities is between about zero and about two g/ml. This difference is preferably between about zero and about 0.5 g/ml.

Useful polymers for the particles include, but are not limited to: polystyrene, polyethylene, polypropylene, phenolic resins, Du Pont Elvax resins (ethylene-vinyl acetate copolymers), polyesters, polyacrylates, polymethacrylates, ethylene acrylic acid or methacrylic acid copolymers (Nucrel Resins—DuPont, Primacor Resins—Dow Chemical), acrylic copolymers and terpolymers (Elvacite Resins, DuPont) and PMMA. Useful materials for homopolymer/pigment phase separation in high shear melt include, but are not limited to, polyethylene, polypropylene, polymethylmethacrylate, polyisobutylmethacrylate, polystyrene, polybutadiene, polyisoprene, polyisobutylene, polylauryl methacrylate, polystearyl methacrylate, polyisobornyl methacrylate, poly-t-butyl methacrylate, polyethyl methacrylate, polymethyl acrylate, polyethyl acrylate, polyacrylonitrile, and copolymers of two or more of these materials. Some useful pigment/polymer complexes that are commercially available include, but are not limited to, Process Magenta PM 1776 (Magruder Color Company, Inc., Elizabeth, N.J.), Methyl Violet PMA VM6223 (Magruder Color Company, Inc., Elizabeth, N.J.), and Naphthol FGR RF6257 (Magruder Color Company, Inc., Elizabeth, N.J.).

The pigment-polymer composite may be formed by a physical process, (e.g., attrition or ball milling), a chemical process (e.g., microencapsulation or dispersion polymerization), or any other process known in the art of particle production. From the following non-limiting examples, it may be seen that the processes and materials for both the fabrication of particles and the charging thereof are generally derived from the art of liquid toner, or liquid immersion development. Thus any of the known processes from liquid development are particularly, but not exclusively, relevant.

New and useful electrophoretic particles may still be discovered, but a number of particles already known to those skilled in the art of electrophoretic displays and liquid toners can also prove useful. In general, the polymer requirements for liquid toners and encapsulated electrophoretic inks are similar, in that the pigment or dye must be easily incorporated therein, either by a physical, chemical, or physicochemical process, may aid in the colloidal stability, and may contain charging sites or may be able to incorporate materials which contain charging sites. One general requirement from the liquid toner industry that is not shared by encapsulated electrophoretic inks is that the toner must be capable of “fixing” the image, i.e., heat fusing together to create a uniform film after the deposition of the toner particles.

Typical manufacturing techniques for particles are drawn from the liquid toner and other arts and include ball milling, attrition, jet milling, etc. The process, will be illustrated for the case of a pigmented polymeric particle. In such a case the pigment is compounded in the polymer, usually in some kind of high shear mechanism such as a screw extruder. The composite material is then (wet or dry) ground to a starting size of around 10 μm. It is then dispersed in a carrier liquid, for example ISOPAR® (Exxon, Houston, Tex.), optionally with some charge control agent(s), and milled under high shear for several hours down to a final particle size and/or size distribution.

Another manufacturing technique for particles drawn from the liquid toner field is to add the polymer, pigment, and suspending fluid to a media mill. The mill is started and simultaneously heated to temperature at which the polymer swells substantially with the solvent. This temperature is typically near 100° C. In this state, the pigment is easily encapsulated into the swollen polymer. After a suitable time, typically a few hours, the mill is gradually cooled back to ambient temperature while stirring. The milling may be continued for some time to achieve a small enough particle size', typically a few microns in diameter. The charging agents may be added at this time. Optionally, more suspending fluid may be added.

Chemical processes such as dispersion polymerization, mini- or micro-emulsion polymerization, suspension polymerization precipitation, phase separation, solvent evaporation, in situ polymerization, seeded emulsion polymerization, or any process which falls under the general category of microencapsulation may be used. A typical process of this type is a phase separation process wherein a dissolved polymeric material is precipitated out of solution onto a dispersed pigment surface through solvent dilution, evaporation, or a thermal change. Other processes include chemical means for staining polymeric lattices, for example with metal oxides or dyes.

### Suspending Fluid

The suspending fluid containing the particles can be chosen based on properties such as density, refractive index, and solubility. In a particular embodiment, suspending fluid has a low dielectric constant (about 2), high volume resistivity (about 10¹⁵ ohm/cm), low viscosity (less than 5 cst), low toxicity and environmental impact, low water solubility (less than 10 ppm), high specific gravity (greater than 1.5), a high boiling point (greater than 90° C.), and a low refractive index (less than 1.2).

The choice of suspending fluid may be based on concerns of chemical inertness, density matching to the electrophoretic particle, or chemical compatibility with both the electrophoretic particle and bounding capsule. The viscosity of the fluid should be low when you want the particles to move. The refractive index of the suspending fluid may also be substantially matched to that of the particles. As used herein, the refractive index of a suspending fluid “is substantially matched” to that of a particle if the difference between their respective refractive indices is between about zero and about 0.3, and is preferably between about 0.05 and about 0.2.

Additionally, the fluid may be chosen to be a poor solvent for some polymers, which is advantageous for use in the fabrication of microparticles because it increases the range of polymeric materials useful in fabricating particles of polymers and pigments. Organic solvents, such as halogenated organic solvents, saturated linear or branched hydrocarbons, silicone oils, and low molecular weight halogen-containing polymers are some useful suspending fluids. The suspending fluid may comprise a single fluid. The fluid will, however, often be a blend of more than one fluid in order to tune its chemical and physical properties. Furthermore, the fluid may contain surface modifiers to modify the surface energy or charge of the electrophoretic particle or bounding capsule. Reactants or solvents for the microencapsulation process (oil soluble monomers, for example) can also be contained in the suspending fluid. Charge control agents can also be added to the suspending fluid.

Useful organic solvents include, but are not limited to, epoxides, such as, for example, decane epoxide and dodecane epoxide; vinyl ethers, such as, for example, cyclohexyl vinyl ether and Decave® (International Flavors & Fragrances, Inc., New York, N.Y.); and aromatic hydrocarbons, such as, for example, toluene and naphthalene. Useful halogenated organic solvents include, but are not limited to, tetrafluorodibromoethylene, tetrachloroethylene, trifluorochloroethylene, 1,2,4-trichlorobenzene, carbon tetrachloride. These materials have high densities. Useful hydrocarbons include, but are not limited to, dodecane, tetradecane, the aliphatic hydrocarbons in the Isopar® series (Exxon, Houston, Tex.), Norpar® (series of normal paraffinic liquids), Shell-Sol® (Shell, Houston, Tex.), and Sol-Trol® (Shell), naphtha, and other petroleum solvents. These materials usually have low densities. Useful examples of silicone oils include, but are not limited to, octamethyl cyclosiloxane and higher molecular weight cyclic siloxanes, poly (methyl phenyl siloxane), hexamethyldisiloxane, and polydimethylsiloxane. These materials usually have low densities. Useful low molecular weight halogen-containing polymers include, but are not limited to, poly(chlorotrifluoroethylene) polymer (Halogenated hydrocarbon-Inc., River Edge, N.J.), Galden® (a perfluorinated ether from Ausimont, Morristown, N.J.), or Krytox® from DuPont (Wilmington, Del.). In one embodiment, the suspending fluid is a poly(chlorotrifluoroethylene) polymer. In a particular embodiment, this polymer has a degree of polymerization from about 2 to about 10. Many of the above materials are available in a range of viscosities, densities, and boiling points.

The fluid must be capable of being formed into small droplets prior to a capsule being formed. Processes for forming small droplets include flow-through jets, membranes, nozzles, or orifices, as well as shear-based emulsifying schemes. The formation of small drops may be assisted by electrical or sonic fields. Surfactants and polymers can be used to aid in the stabilization and emulsification of the droplets in the case of an emulsion type encapsulation. One surfactant useful in displays of the invention is sodium dodecylsulfate.

It can be advantageous in some displays for the suspending fluid to contain an optically absorbing dye. This dye must be soluble in the fluid, but will generally be insoluble in the other components of the capsule. There is much flexibility in the choice of dye material. The dye can be a pure compound, or blends of dyes to achieve a particular color, including black. The dyes can be fluorescent, which would produce a display in which the fluorescence properties depend on the position of the particles. The dyes can be photoactive, changing to another color or becoming colorless upon irradiation with either visible or ultraviolet light, providing another means for obtaining an optical response. Dyes could also be polymerizable, forming a solid absorbing polymer inside the bounding shell.

There are many dyes that can be chosen for use in encapsulated electrophoretic display. Properties important here include light fastness, solubility in the suspending liquid, color, and cost. These are generally from the class of azo, anthraquinone, and triphenylmethane type dyes and may be chemically modified so as to increase the solubility in the oil phase and reduce the adsorption by the particle surface.

A number of dyes already known to those skilled in the art of electrophoretic displays will prove useful. Useful azo dyes include, but are not limited to: the Oil Red dyes, and the Sudan Red and Sudan Black series of dyes. Useful anthraquinone dyes include, but are not limited to: the Oil Blue dyes, and the Macrolex Blue series of dyes. Useful triphenylmethane dyes include, but are not limited to, Michler's hydrol, Malachite Green, Crystal Violet, and Auramine 0.

### Charge Control Agents and Particle Stabilizers

Charge control agents are used to provide good electrophoretic mobility to the electrophoretic particles. Stabilizers are used to prevent agglomeration of the electrophoretic particles, as well as prevent the electrophoretic particles from irreversibly depositing onto the capsule wall. Either component can be constructed from materials across a wide range of molecular weights (low molecular weight, oligomeric, or polymeric), and may be pure or a mixture. In particular, suitable charge control agents are generally adapted from the liquid toner art. The charge control agent used to modify and/or stabilize the particle surface charge is applied as generally known in the arts of liquid toners, electrophoretic displays, non-aqueous paint dispersions, and engine-oil additives. In all of these arts, charging species may be added to non-aqueous media in order to increase electrophoretic mobility or increase electrostatic stabilization. The materials can improve steric stabilization as well. Different theories of charging are postulated, including selective ion adsorption, proton transfer, and contact electrification.

Optionally, charge control agents or charge directors may be used. These constituents typically include low molecular weight surfactants, polymeric agents, or blend of one or more components and serve to stabilize or otherwise modify the sign and/or magnitude of the charge on the electrophoretic particles. The charging properties of the pigment itself may be accounted for by taking into account the acidic or basic surface properties of the pigment, or the' charging sites may take place on the carrier resin surface (if present), or a combination of the two.

Additional relevant pigment properties include the particle size distribution, the chemical composition, and the lightfastness. The charge control agent used to modify and/or stabilize the particle surface charge is applied as generally known in the arts of liquid toners, electrophoretic displays, non-aqueous paint dispersions, and engine-oil additives. In all of these arts, charging species may be added to non-aqueous media in order to increase electrophoretic mobility or increase electrostatic stabilization. The materials can improve steric stabilization as well. Different theories of charging are postulated, including selective ion adsorption, proton transfer, and contact electrification.

Charge adjuvants may also be added. These materials increase the effectiveness of the charge control agents or charge directors. The charge adjuvant may be a polyhydroxy compound or an aminoalcohol compound, which are preferably soluble in the suspending fluid in an amount of at least 2% by weight. Examples of polyhydroxy compounds which contain at least two hydroxyl groups include, but are not limited to, ethylene glycol, 2,4,7,9-tetramethyl-decyne-4,7-diol, polypropylene glycol), pentaethylene glycol, tripropylene glycol, triethylene glycol, glycerol, pentaerythritol, glycerol tris(12-hydroxystearate), propylene glycerol monohydroxystearate, and ethylene glycol monohydroxystearate. Examples of aminoalcohol compounds which contain at least one alcohol function and one amine function in the same molecule include, but are not limited to, triisopropanolamine, triethanolamine, ethanolamine, 3-amino-1-propanol, o-aminophenol, 5-amino-1-pentanol, and tetrakis(2-hydroxyethyl)ethylene-diamine. The charge adjuvant is preferably present in the suspending fluid in an amount of about 1 to about 100 mg/g of the particle mass, and more preferably about 50 to about 200 mg/g.

The surface of the particle may also be chemically modified to aid dispersion, to improve surface charge, and to improve the stability of the dispersion, for example. Surface modifiers include organic siloxanes, organohalogen silanes and other functional silane coupling agents (Dow Corning® Z-6070, Z-6124, and 3 additive, Midland, Mich.); organic titanates and zirconates (Tyzor® TOT, TBT, and TE Series, DuPont, Wilmington, Del.); hydrophobing agents, such as long chain (C₁₂ to C₅₀) alkyl and alkyl benzene sulphonic acids, fatty amines or diamines and their salts or quaternary derivatives; and amphipathic polymers which can be covalently bonded to the particle surface.

In general, it is believed that charging results as an acid-base reaction between some moiety present in the continuous phase and the particle surface. Thus useful materials are those which are capable of participating in such a reaction, or any other charging reaction as known in the art.

Different non-limiting classes of useful charge control agents include organic sulfates or sulfonates, metal soaps, block or comb copolymers, organic amides, organic zwitterions, and organic phosphates and phosphonates. Useful organic sulfates and sulfonates include, but are not limited to, sodium bis(2-ethyl hexyl) sulfosuccinate, calcium dodecyl benzene sulfonate, calcium petroleum sulfonate, neutral or basic barium dinonylnaphthalene sulfonate, neutral or basic calcium dinonylnaphthalene sulfonate, dodecylbenzenesulfonic acid sodium salt, and ammonium lauryl sulphate. Useful metal soaps include, but are not limited to, basic or neutral barium petronate, calcium petronate, Co—, Ca—, Cu—, Mn—, Ni—, Zn—, and Fe— salts of naphthenic acid, Ba—, Al—, Zn—, Cu—, Pb—, and Fe— salts of stearic acid, divalent and trivalent metal carboxylates, such as aluminum tristearate, aluminum octoanate, lithium heptanoate, iron stearate, iron distearate, barium stearate, chromium stearate, magnesium octanoate, calcium stearate, iron naphthenate, and zinc naphthenate, Mn— and Zn— heptanoate, and Ba—, Al—, Co—, Mn—, and Zn— octanoate. Useful block or comb copolymers include, but are not limited to, AB diblock copolymers of (A) polymers of 2-(N,N)-dimethylaminoethyl methacrylate quaternized with methyl-p-toluenesulfonate and (B) poly-2-ethylhexyl methacrylate, and comb graft copolymers with oil soluble tails of poly (12-hydroxystearic acid) and having a molecular weight of about 1800, pendant on an oil-soluble anchor group of poly(methyl methacrylate-methacrylic acid). Useful organic amides include, but are not limited to, polyisobutylene succinimides such as OLOA 1200 and 3700, and N-vinyl pyrrolidone polymers. Useful organic zwitterions include, but are not limited to, lecithin. Useful organic phosphates and phosphonates include, but are not limited to, the sodium salts of phosphated mono- and diglycerides with saturated and unsaturated acid substituents.

Particle dispersion stabilizers may be added to prevent particle flocculation or attachment to the capsule walls. For the typical high resistivity liquids used as suspending fluids in electrophoretic displays, nonaqueous surfactants may be used. These include, but are not limited to, glycol ethers, acetylenic glycols, alkanolamides, sorbitol derivatives, alkyl amines, quaternary amines, imidazolines, dialkyl oxides, and sulfosuccinates.

### Encapsulation

Liquids and particles can be encapsulated, for example, within a membrane or in a binder material. Moreover, there is a long and rich history to encapsulation, with numerous processes and polymers having proven useful in creating capsules. Encapsulation of the internal phase may be accomplished in a number of different ways. Numerous suitable procedures for microencapsulation are detailed in both Microencapsulation, Processes and Applications, (I. E. Vandegaer, ed.), Plenum Press, New York, N.Y. (1974) and Gutcho, Microcapsules and Mircroencapsulation Techniques, Nuyes Data Corp., Park Ridge, N.J. (1976). The processes fall into several general categories, all of which can be applied to the present invention: interfacial polymerization, in situ polymerization, physical processes, such as coextrusion and other phase separation processes, in-liquid curing, and simple/complex coacervation.

Numerous materials and processes should prove useful in formulating displays of the present invention. Useful materials for simple coacervation processes include, but are not limited to, gelatin, polyvinyl alcohol, polyvinyl acetate, and cellulosic derivatives, such as, for example, carboxymethylcellulose. Useful materials for complex coacervation processes include, but are not limited to, gelatin, acacia, carageenan, carboxymethylcellulose, hydrolyzed styrene anhydride copolymers, agar, alginate, casein, albumin, methyl vinyl ether co-maleic anhydride, and cellulose phthalate. Useful materials for phase separation processes include, but are not limited to, polystyrene, PMMA, polyethyl methacrylate, polybutyl methacrylate, ethyl cellulose, polyvinyl pyridine, and poly acrylonitrile. Useful materials for in situ polymerization processes include, but are not limited to, polyhydroxyamides, with aldehydes, melamine, or urea and formaldehyde; water-soluble oligomers of the condensate of melamine, or urea and formaldehyde; and vinyl monomers, such as, for example, styrene, MMA and acrylonitrile. Finally, useful materials for interfacial polymerization processes include, but are not limited to, diacyl chlorides, such as, for example, sebacoyl, adipoyl, and di- or poly-amines or alcohols, and isocyanates. Useful emulsion polymerization materials may include, but are not limited to, styrene, vinyl acetate, acrylic acid, butyl acrylate, t-butyl acrylate, methyl methacrylate, and butyl methacrylate.

Capsules produced may be dispersed into a curable carrier, resulting in an ink which may be printed or coated on large and arbitrarily shaped or curved surfaces using conventional printing and coating techniques.

In the context of the present invention, one skilled in the art will select an encapsulation procedure and wall material based on the desired capsule properties. These properties include the distribution of capsule radii, electrical, mechanical, diffusion, and optical properties of the capsule wall; and chemical compatibility with the internal phase of the capsule.

The capsule wall generally has a high electrical resistivity. Although it is possible to use walls with relatively low resistivities, this may limit performance in requiring relatively higher addressing voltages. The capsule wall should also be mechanically strong (although if the finished capsule powder is to be dispersed in a curable polymeric binder for coating, mechanical strength is not as critical). The capsule wall should generally not be porous. If, however, it is desired to use an encapsulation procedure that produces porous capsules, these can be overcoated in a post-processing step (i.e., a second encapsulation). Moreover, if the capsules are to be dispersed in a curable binder, the binder will serve to close the pores. The capsule walls should be optically clear. The wall material may, however, be chosen to match the refractive index of the internal phase of the capsule (i.e., the suspending fluid) or a binder in which the capsules are to be dispersed. For some applications (e.g., interposition between two fixed electrodes), monodispersed capsule radii are desirable.

An encapsulation procedure involves a polymerization between urea and formaldehyde in an aqueous phase of an oil/water emulsion in the presence of a negatively charged, carboxyl-substituted, linear hydrocarbon polyelectrolyte material. The resulting capsule wall is a urea/formaldehyde copolymer, which discretely encloses the internal phase. The capsule is clear, mechanically strong, and has good resistivity properties.

The related technique of in situ polymerization utilizes an oil/water emulsion, which is formed by dispersing the electrophoretic composition (i.e., the dielectric liquid containing a suspension of the pigment particles) in an aqueous environment. The monomers polymerize to form a polymer with higher affinity for the internal phase than for the aqueous phase, thus condensing around the emulsified oily droplets. In one especially useful in situ polymerization processes, urea and formaldehyde condense in the presence of poly(acrylic acid) (See, e.g., U.S. Pat. No. 4,001,140). In other useful process, any of a variety of cross-linking agents borne in aqueous solution is deposited around microscopic oil droplets. Such cross-linking agents include aldehydes, especially formaldehyde, glyoxal, or glutaraldehyde; alum; zirconium salts; and poly isocyanates. The entire disclosures of U.S. Pat. Nos. 4,001,140 and 4,273,672 are hereby incorporated by reference herein.

The coacervation approach also utilizes an oil/water emulsion. One or more colloids are coacervated (i.e., agglomerated) out of the aqueous phase and deposited as shells around the oily droplets through control of temperature, pH and/or relative concentrations, thereby creating the microcapsule. Materials suitable for coacervation include gelatins and gum arabic.

The interfacial polymerization approach relies on the presence of an oil-soluble monomer in the electrophoretic composition, which once again is present as an emulsion in an aqueous phase. The monomers in the minute hydrophobic droplets react with a monomer introduced into the aqueous phase, polymerizing at the interface between the droplets and the surrounding aqueous medium and forming shells around the droplets. Although the resulting walls are relatively thin and may be permeable, this process does not require the elevated temperatures characteristic of some other processes, and therefore affords greater flexibility in terms of choosing the dielectric liquid.

Coating aids can be used to improve the uniformity and quality of the coated or printed electrophoretic ink material. Wetting agents are typically added to adjust the interfacial tension at the coating/substrate interface and to adjust the liquid/air surface tension. Wetting agents include, but are not limited to, anionic and cationic surfactants, and nonionic species, such as silicone or fluoropolymer based materials. Dispersing agents may be used to modify the interfacial tension between the capsules and binder, providing control over flocculation and particle settling.

Surface tension modifiers can be added to adjust the air/ink interfacial tension. Polysiloxanes are typically used in such an application to improve surface leveling while minimizing other defects within the coating. Surface tension modifiers include, but are not limited to, fluorinated surfactants, such as, for example, the Zonyl® series from DuPont (Wilmington, Del.), the Fluorod® series from 3M (St. Paul, Minn.), and the fluoroalkyl series from Autochem (Glen Rock, N.J.; siloxanes, such as, for example, Silwet® from Union Carbide (Danbury, Conn.); and polyethoxy and polypropoxy alcohols. Antifoams, such as silicone and silicone-free polymeric materials, may be added to enhance the movement of air from within the ink to the surface and to facilitate the rupture of bubbles at the coating surface. Other useful antifoams include, but are not limited to, glyceryl esters, polyhydric alcohols, compounded antifoams, such as oil solutions of alkyl benzenes, natural fats, fatty acids, and metallic soaps, and silicone antifoaming agents made from the combination of dimethyl siloxane polymers and silica. Stabilizers such as uv-absorbers and antioxidants may also be added to improve the lifetime of the ink.

Other additives to control properties like coating viscosity and foaming can also be used in the coating fluid. Stabilizers (UV-absorbers, antioxidants) and other additives which could prove useful in practical materials.

### Binder Material

The binder is used as a non-conducting, adhesive medium supporting and protecting the capsules, as well as binding the electrode materials to the capsule dispersion. Binders are available in many forms and chemical types. Among these are water-soluble polymers, water-borne polymers, oil-soluble polymers, thermoset and thermoplastic polymers, and radiation-cured polymers.

Among the water-soluble polymers are the various polysaccharides, the polyvinyl alcohols, N-methylpyrrolidone, N-vinylpyrrolidone, the various Carbowax® species (Union Carbide, Danbury, Conn.), and poly-2-hydroxyethylacrylate.

The water-dispersed or water-borne systems are generally latex compositions, typified by the Neorez® and Neocryl® resins (Zeneca Resins, Wilmington, Mass.), Acrysol® (Rohm and Haas, Philadelphia, Pa.), Bayhydrol® (Bayer, Pittsburgh, Pa.), and the Cytec Industries (West Paterson, N.J.) HP line. These are generally latices of polyurethanes, occasionally compounded with one or more of the acrylics, polyesters, polycarbonates or silicones, each lending the final cured resin in a specific set of properties defined by glass transition temperature, degree of “tack,” softness, clarity, flexibility, water permeability and solvent resistance, elongation modulus and tensile strength, thermoplastic flow, and solids level. Some water-borne systems can be mixed with reactive monomers and catalyzed to form more complex resins. Some can be further cross-linked by the use of a crosslinking reagent, such as an aziridine, for example, which reacts with carboxyl groups.

A typical application of a water-borne resin and aqueous capsules follows. A volume of particles is centrifuged at low speed to separate excess water. After a given centrifugation process, for example 10 minutes at 60×G, the capsules are found at the bottom of the centrifuge tube, while the water portion is at the top. The water portion is carefully removed (by decanting or pipetting). The mass of the remaining capsules is measured, and a mass of resin is added such that the mass of resin is between one eighth and one tenth of the weight of the capsules. This mixture is gently mixed on an oscillating mixer for approximately one half hour. After about one half hour, the mixture is ready to be coated onto the appropriate substrate.

The family of epoxies exemplifies the thermoset systems. These binary systems can vary greatly in viscosity, and the reactivity of the pair determines the “pot life” of the mixture. If the pot life is long enough to allow a coating operation, capsules may be coated in an ordered arrangement in a coating process prior to the resin curing and hardening.

Thermoplastic polymers, which are often polyesters, are molten at high temperatures. A typical application of this type of product is hot-melt glue. A dispersion of heat-resistant capsules could be coated in such a medium. The solidification process begins during cooling, and the final hardness, clarity and flexibility are affected by the branching and molecular weight of the polymer.

Oil or solvent-soluble polymers are often similar in composition to the water-borne system, with the obvious exception of the water itself. The latitude in formulation for solvent systems is enormous, limited only by solvent choices and polymer solubility. Of considerable concern in solvent-based systems is the viability of the capsule itself—the integrity of the capsule wall cannot be compromised in any way by the solvent.

Radiation cure resins are generally found among the solvent-based systems. Capsules may be dispersed in such a medium and coated, and the resin may then be cured by a timed exposure to a threshold level of very violet radiation, either long or short wavelength. As in all cases of curing polymer resins, final properties are determined by the branching and molecular weights of the monomers, oligomers, and crosslinkers.

A number of “water-reducible” monomers and oligomers are, however, marketed. In the strictest sense, they are not water soluble, but water is an acceptable diluent at low concentrations and can be dispersed relatively easily in the mixture. Under these circumstances, water is used to reduce the viscosity (initially from thousands to hundreds of thousands centipoise). Water-based capsules, such as those made from a protein or polysaccharide material, for example, could be dispersed in such a medium and coated, provided the viscosity could be sufficiently lowered. Curing in such systems is generally by ultraviolet radiation.

While the invention has been particularly shown and described with reference to specific embodiments, it should be understood by those skilled in the art that various changes in form and detail may be made therein without departing from the spirit and scope of the invention.

1. A method for addressing a backplane having first and second edges, the method comprising the steps of: disposing a plurality of first terminations and a plurality of second terminations proximate to the first edge; providing a plurality of row electrodes, one row electrode being in electric communication with each first termination; providing a plurality of column electrodes, one column electrode being in electric communication with each second termination, the plurality of column electrodes intersecting with the plurality of row electrodes at a two-dimensional array of pixels; and directing an electric signal to at least one of the first and second terminations.

2. The method of claim 1 wherein the backplane is disposed adjacent a nonemissive electro-optic display medium selected from the group consisting of: a microencapsulated electrophoretic display medium; an electrochromic display medium, a microcell electrophoretic display medium, and a rotating bichromal member display medium.

3. The method of claim 1, further comprising the step of providing a conductive pad in electric communication with at least one of the terminations.

4. The method of claim 1, further comprising the step of establishing electric communication between each second termination and its associated column electrode via a trace intersecting the column electrode at an angle.

5. The method of claim 1, further comprising the step of providing a driver circuitry in electrical communication with at least one of the first and second terminations, at least a portion of the driver circuitry being reversibly removable from the backplane.

6. The method of claim 5 wherein the driver circuitry is in permanent electric communication with an electronic device having an internal display addressable by the driver circuitry.

7. The method of claim 6 wherein the electronic device is selected from the group consisting of: a cellular telephone, a personal digital assistant, a general-purpose computer, an electronic book, a two-way radio, a set-top box, a webpad, and an electronic hand-held device.

8. The method of claim 5, further comprising the steps of: providing an addressing module comprising a driver circuitry and defining a groove shaped and dimensioned to receive the first edge of the backplane, the groove having a set of contacts in electric communication with the driver circuitry; disposing the first edge of the backplane in the groove such that electric communication is established between at least one of the first and second terminations and the set of contacts.
